(19) United States
(12) Patent Application Publication
(10) Pub. No.: US 2016/0120191 A1
(43) Pub. Date: May 5, 2016

(54) Ready-To-Bake Gluten-Free Cookie Dough

(71) Applicant: General Mills, Inc., Minneapolis, MN (US)

(72) Inventors: Michelle Dacey, Golden Valley, MN (US); Christine O'Connor, Rogers, MN (US)

(73) Assignee: General Mills, Inc., Minneapolis, MN (US)

(21) Appl. No.: 14/894,093

(22) PCT Filed: May 31, 2013
(86) PCT No.: PCT/US13/43774

§ 371 Date: Nov. 25, 2015

(51) Int. Cl. A21D 10/02; A21D 13/06; A21D 2/34; A21D 2/36; A21D 2/18; A21D 2/16

(52) U.S. Cl. CPC A21D 10/025; A21D 2/186; A21D 2/165; A21D 2/183; A21D 2/34; A21D 2/36; A21D 13/066

(57) ABSTRACT

A composition includes a gluten-free flour mixture constituting from 25% to 30% by weight of the composition, shortening from 10% to 20% by weight of the composition, sucrose from 21% to 35% by weight of the composition and water in less than 12% by weight of the composition. The gluten-free flour mixture includes less than 30% rice flour by weight of the composition, less than 2.5% potato starch by weight of the composition, and tapioca starch, corn starch or combinations of tapioca starch and corn starch. The composition has a water activity of less than 0.82. Methods of manufacturing the composition are also provided.

### BACKGROUND

Gluten is a protein found in a variety of grains including wheat, rye, and barley, with wheat containing the highest levels of gluten when compared to other cereal grains. Although wheat flour is typically referred to as containing gluten, in reality, wheat flour contains two proteins, gliadin and glutenin, which when hydrated combine to form gluten.

Gluten is responsible for the texture and taste of wheat flour-based baked goods such as cookies, brownies, and breads. Upon hydration, gluten forms a network of fine strands that give the dough structure and the capacity to stretch and/or rise during baking. The elasticity of gluten enables the dough to trap gases, which create open cellular structures upon baking.

Gluten also affects the viscosity of dough. As described above, gluten forms the structure of the dough. The extent of the network of gluten strands impacts whether a mixture is thin and runny, like a batter, or is thick, like a dough. For cookie dough, wheat flour typically can make up between 20% and 30% by weight of the dough.

Some individuals are sensitive or intolerant to gluten. Recently there has been a growing trend to provide gluten-free baked goods. While consumers are demanding gluten-free products, it is very difficult to produce gluten-free products having a similar taste and texture as traditional gluten and/or wheat flour containing products because, as described above, gluten provides the structure or framework for traditional baked goods. When wheat flour is replaced with a gluten-free flour, such as rice flour, the dough lacks a matrix to create the structure and texture typically associated with comparable gluten containing baked goods. For example, gluten-free dough may not have the same elasticity as a gluten dough, and may be drier and more difficult to handle.

Currently, gluten-free cookie dough dry mixes are commercially available. Such dry mixes require the consumer to add ingredients, such as butter, oil, and eggs, to a provided dry mixture. These mixes tend to produce doughs and baked products that are not as satisfying as the gluten containing products. For example the taste, texture and mouth feel of the baked product may not be satisfactory as compared to a gluten containing baked product and the baked product may be dry and have a crumbly and/or a gritty texture.

Further, consumers enjoy the modern convenience of ready-to-bake products which can go directly from the pantry, refrigerator or freezer to the oven or other associated baking appliance without the need for additional preparation steps and/or the addition of ingredients. Particularly, there is demand for ready-to-bake gluten-free products that can go directly from the refrigerator to the oven or other associated baking appliance.

Ready-to-bake gluten-free dough adds additional challenges including shelf stability, dough handling properties and the inability for consumers to adjust or manipulate the ingredients of the dough. Ready-to-bake products must be capable of being stored under refrigerated conditions for an extended period of time (i.e., at least 75 days or at least 90 days, in some cases as long as 120 days).

Ready-to-bake doughs also face the additional challenge that the consumers cannot change or adjust the ingredients of the dough. Unlike dry mixes in which the consumer can adjust the amount of certain ingredients added to the dough to adjust the composition, the consumer is unable to add or adjust the content of a ready-to-bake dough.

### SUMMARY

The present invention relates to shelf stable, ready-to-bake gluten-free cookie dough formulations and methods of making these formulations.

One embodiment is a composition including a gluten-free flour mixture constituting from 25% to 30% by weight of the composition, shortening from 10% to 20% by weight of the composition, sucrose from 21% to 35% by weight of the composition and water in less than 12% by weight of the composition. The gluten-free flour mixture includes less than 30% rice flour by weight of the composition, less than 2.5% potato starch by weight of the composition, and tapioca starch, corn starch or combinations of tapioca starch and corn starch. The composition has a water activity of less than 0.82.

In another embodiment, a raw dough product is manufactured by combining rice flour, potato starch, at least one of tapioca starch and corn starch, shortening, sucrose, and water, forming a raw dough product and packaging the raw dough product. The raw dough product has a water activity of 0.82 or less.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION

The current invention relates to ready-to-bake gluten-free cookie dough formulations. In some embodiments, the gluten-free cookie dough is spoonable, resembles a gluten containing dough, is be capable of being stored for a long period time in the refrigerator without the need for hermetic or pressurized sealing, and produces a baked product comparable to that obtained with gluten containing doughs.

According to some embodiments, the ready-to-bake gluten-free cookie dough includes a flour mixture, shortening, sucrose, and water. Gluten-free pie doughs according to embodiments of the present invention contain less than 20 ppm gluten and more particularly less than 0% by weight of gluten. In some embodiments, gluten content may be determined by the gliadin content. A suitable method for determining the gluten content of a food product is provided in Association of Analytical Communities (AOAC) Official Method 991.19: Gliadin as a Measure of Gluten in Foods (final action 2001). In some embodiments, the cookie dough may include from about 13% to about 27% liquid ingredients, including fat (i.e., solid shortening) and water, by weight of the dough and from about 66% to about 89% dry ingredients, including the gluten-free flour mixture and sucrose by weight of the dough.

In some embodiments, the gluten-free flour mixture may be present in the ready-to-bake gluten-free cookie dough in an amount from about 25% to about 30% by weight of the dough. The gluten-free flour mixture may include, consist essentially of or consist of rice flour, potato starch and at least one of tapioca starch and corn starch. The gluten-free flour mixture is a substitute for wheat flour and/or other gluten containing flours traditionally used in cookie dough. The combination of several ingredients contained in the gluten-free dough described herein provides a ready-to-bake cookie dough having taste, texture and rheology similar to that of gluten containing doughs, and provides baked products comparable to gluten containing baked goods.

Rice flour does not contain gluten, gliadin or glutenin. Suitable forms of rice flour include short grain and long grain white and brown rice. To prevent a gritty baked cookie product, the dough may include less than about 30% by weight of rice flour, and more particularly less than about 23% by weight of rice flour. For example, rice flour may be present in amount from about 18% to about 30% by weight of the dough, more particularly from about 18% to about 23%.

Because the rice flour is not a direct substitute for wheat flour, the gluten-free flour mixture also includes potato starch and optionally additional starches to provide additional structural and textural properties that rice flour alone cannot accomplish. However, to prevent off-flavors, the gluten-free flour mixture may include less than about 2.5% potato starch by weight of the dough, and more particularly less than about 2%. For example, potato starch may be present in an amount from about 1.0% to 2.5% by weight of the dough, and more particularly from about 1.5% to 2% by weight of the dough.

The gluten-free flour mixture may further include at least one of tapioca starch, corn starch and combinations thereof. In some embodiments, the tapioca and/or corn starch may be native or unmodified starch(s). In other embodiments, the tapioca and/or corn starch may be modified starch(s). Modified starches can be prepared by physically, enzymatically or chemically treating the native starch to change the properties of the starch. The inclusion of tapioca starch and/or corn starch into the ready-to-bake cookie dough may provide a dough texture similar to wheat based dough without creating off-flavors. To maintain a desired moisture level and spread characteristics, the ready-to-bake cookie dough may include less than about 4.5% by weight of tapioca starch and/or corn starch. For example, suitable dough may include from about 3.5% to about 4.5% by weight tapioca starch and/or corn starch.

The ready-to-bake dough also includes solid shortening. Animal or vegetable based natural shortenings can be used, as can synthetic shortenings. Shortening is generally comprised of triglycerides, fats and fatty oils that are made predominantly from tri-esters of glycerol with fatty acids. Fats and fatty oils that may be found in the shortening include cottonseed oil, nut oil, soybean oil, sunflower oil, rapeseed oil, sesame oil, olive oil, corn oil, safflower oil, palm oil, palm kernel oil, coconut oil, and combinations thereof. The shortening may have beneficial effects on the volume, grain and texture of the dough, as well as the texture, mouth feel and other organoleptic properties of the baked product. In some embodiments, the shortening may affect the spread of the dough during baking and the texture of the baked cookie. Suitable amounts of shortening include from about 10% to about 20% by weight of the dough, and more particularly from about 12% to about 17%.

The ready-to-bake dough also includes sugars. Useful sugars include saccharides such as monosaccharides and disaccharides. Monosaccharides typically have 5 or 6 carbon atoms, and have the general empirical formula Cₙ(H₂O)ₙ. Disaccharides consist of two monosaccharides joined together with the concomitant loss of a water molecule. Illustrative but non-limiting examples of suitable sugars include pentoses such as fructose, xylose, arabinose, glucose, galactose, amylose, fructose, sorbose, lactose, maltose, dextrose, sucrose, maltodextrins, high fructose corn syrup (HFCS), and molasses. Particularly suitable sucrose includes white sugar, brown sugar and combinations thereof. Sugar is present in the ready-to-bake dough to provide sweetness and may affect the spread of the dough during baking. Suitable amounts of sugar includes from about 21% to about 35% by weight of the dough, and more particularly from about 24% to about 30%. In some embodiments, the ready-to-bake dough may include a greater amount of brown sugar than white sugar. For example, in some embodiments, the ready-to-bake dough may include from about 4% to about 5% by weight granulated white sugar and about 20% to about 25% by weight brown sugar. In other embodiments the ready-to-bake dough may include only one sugar source, such as all white granulated sugar or all brown sugar. In some embodiments, the sugar source may affect the color and flavor (i.e., sweetness) of the baked product. For example, in some embodiments, the inclusion of brown sugar may produce a darker baked product as compared to a product in which all or a portion of the brown sugar is substituted with granulated white sugar.

Sugar may lower the water activity, a_{w}, of the dough. Water activity is a measure of the equilibrated water vapor pressure generated by the product divided by the vapor pressure of pure water at the same temperature as shown in Formula (1).

a_{w}=p/p₀ (1)

where p is the vapor pressure of water in the substance, and p₀ is the vapor pressure of pure water at the same temperature. Lowering the water activity provides the microbial stability required to impart shelf stability under refrigerated conditions for extended periods of time (e.g., at least about 75 days or at least about 90 days or up to 120 days). In some embodiments, the dough of the invention has a water activity of less than about 0.85. For example, the dough of the invention may have a water activity of between about 0.78 and 0.85. In other embodiments, the dough of the invention may have a water activity between about 0.78 and 0.80. If the water activity is higher, then microbial stability over extended periods of time is reduced unless the water in the dough is frozen. If the water activity is lower, then the microbial stability under refrigeration temperatures is satisfactory, but the amount of water available is so low that the resulting end product may not have a high volume and fluffy texture and may be unacceptably dry.

As described herein, sugar may lower the water activity of the dough. Because sugar also impart sweetness to the baked product, the kind and amount of sugar is selected to achieve a balance between reducing the water activity of the composition a sufficient amount to provide microbial stability and obtaining the desired degree and quality of sweetness in the baked product. This can be achieved by balancing both the ratios of various sugar sources to one another and the ratios of sugar to water in the dough.

The ready-to-bake dough may further include water in an amount less than about 12% by weight, and more particularly less than about 10% by weight. For example, the dough may include water in amount from about 1% to about 12% by weight of the dough, and more particularly from about 1% to about 10% by weight of the dough. The water content affects the texture and consistency of the ready-to-bake dough, as well as the water activity. In some embodiments, it is desired to produce a ready-to-bake dough that has the same texture and consistency as a typical gluten containing dough, i.e., a dough that is spoonable and that is sufficiently moist to enable the dough to be formed into shapes, such as balls, for baking without crumbling. Too much water creates a dough that is too moist to stick together, while too little water creates a dough that is too dry to stick together.

The ready-to-bake dough may also include egg solids. Suitable sources of egg solids include whole eggs (albumen and yolk) and dried whole eggs. Egg whites and dried egg whites may also be used. The egg solids contribute to the structure of the dough. More specifically, proteins from the egg solids provide a matrix or bind the ingredients together to form a suitable dough. In some embodiments, the dough may include about 1% to about 4%, and more particularity from about 1.8% to about 2.2%, by weight egg solids. Too much egg solids may create a stiff dough and may affect the taste of the dough, while too little egg solids will not provide a proper structure for the dough and the dough will fall apart.

Salt may be added to the dough formulation. The salt may be used for flavor purposes and/or to reduce water activity. Suitable amounts of salt include from about 0% to about 1.5% by weight of the dough, and more particularly from about 0.3% to about 0.8%.

The ready-to-bake dough may include a leavening system. A chemical leavening system may include an acid and a base that can react to form carbon dioxide. Suitable leavening systems may include baking soda (sodium bicarbonate or potassium bicarbonate), monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), sodium bicarbonate and the like. Baking soda is a leavening base and is the primary source of carbon dioxide in many chemical leavening systems. This compound is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur. In some embodiments, the dough may include from about 0.2% to about 0.75% of a leavening system, such as baking soda, by weight, and more particularly from about 0.3% to about 0.6%.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan and the like. In some embodiments, hydrocolloids or gums may be present in an amount from about 0.2% to about 0.75% by weight of the dough, and more particularly from about 0.2% to about 0.5%.

In some embodiments, the ready-to-bake dough may include one or more antimicrobial agent(s) to enhance microbial stability. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.25% to about 1.5% by weight of the dough. If the agent(s) are used in too little of an amount, the agents will not provide a sufficient effect, while too much can impart an off taste to the dough. Additionally suitable agents include cultured dextrose in an amount effective to inhibit the growth of undesired pathogens and spoilage organisms, such as Lactobacilli, yeast, molds, Listeria monocytogenes and heat-resistant spore formers. Suitable cultured dextrose includes MicroGARD 730 available from Danisco USA. Suitable amounts of cultured dextrose include from about 0.25% to 1.5% by weight of the dough. Combinations of antimicrobial agents may also be used.

In some embodiments, the dough may have a pH from about 7 to 8.5, preferably about 8 to 8.5. The antimicrobial agent(s) may be selected to provide sufficient inhibition at these pH levels.

In some embodiments, the rice flour may be heat treated before addition to the ready-to-bake dough to reduce and/or eliminate micro-organisms. For example, radio waves, such as macrowaves, may be applied to the rice flour for a sufficient time and temperature to reduce the microbiological activity of the flour by a sufficient amount, such as by at least a five log reduction. If the rice flour is not treated at a high enough temperature and/or for a long enough time period (i.e., under treated), the microbiological activity of the flour may not be sufficiently reduced. Further, if the rice flour is treated at too high of a temperature and/or for too long of a time period (i.e., over treated) the flour may be clumpy and may produce undesired lumps in the resulting dough. Additionally or alternatively, other flours of the gluten-free flour mixture may also be treated to reduce and/or eliminate microbiological activity.

In some embodiments, the ready-to-bake dough may be low in trans fatty acids (i.e., “low trans”) or may be free of trans fatty acids (i.e., “trans free”). Compositions that are low in trans fatty acids may comprise about 50% by weight or less of trans fatty acids. Compositions of that are free of trans fatty acids may comprise about 4% by weight or less of trans fatty acids. In some embodiments, the dough may be low trans or trans free and have total fat content from about 11% to about 16% by weight of the dough.

In addition to the foregoing, other ingredients known to those of skill in the art can be included in the compositions to give a variety of desired properties, flavors and/or textures. Examples of these ingredients include flavoring and coloring agents, flavors, spices, flavor identifying particulates such as fruit, chocolate, or nuts, and the like.

Exemplary ready-to-bake stable cookie dough compositions are provided in Table 1 and exemplary gluten-free flour mixtures for use in the pie dough composition are provided in Table 2. All components in Table 1 and Table 2 are provided as weight percent of the dough composition.

TABLE 1
Ready-to-bake cookie dough compositions

| | Range 1 | Range 2 |
|---|---|---|
| | (wt %) | (wt %) |
| Gluten-free flour mixture | 25-30% | 25-30% |
| Solid shortening | 10-20% | 12-17% |
| Sugar | 21-35% | 24-30% |
| Water | 1-12% | 1-10% |
| Leavening system | 0.2-0.75% | 0.3-0.6% |
| Gums | 0.2-0.75% | 0.2-0.5% |
| Egg solids | 1-4% | 1.8-2.2% |
| Salt | 0-1.5% | 0.3-0.8% |
| Chocolate chips (flavor | 15-25% | 15-25% |
| identifying particulates) | | |
| Antimicrobial (optional) | 0-1.5% | 0.25-1.5% |

TABLE 2
Gluten-free flour mixtures

| | Range 1 | Range 2 |
|---|---|---|
| | (wt %) | (wt %) |
| Rice flour | 18-30% | 18-23% |
| Potato starch | 1-2.5% | 1.5-2% |
| Blend of corn starch and tapioca starch | 3.5-4.5% | 3.5-4.5% |

The ready-to-bake dough may be prepared by combining the ingredients by stirring in a standard mixer such as a Sigma mixer. Preferably the mixing is carried out under refrigerated conditions, about 35 to 70° F. (1.7-21° C.), and more particularly about 65° F. (18.3° C.). The dough may be produced by a four stage mixing process. First, the shortening and sugar may be creamed together. Next, the liquid ingredients, such as water and vanilla, may be added to the creamed mixture, followed by the remaining dry ingredients such as the gluten-free flour mixture and leavening system. Any flavor identifying particulates, such as fruit, chocolate or nuts, are added last, after the dry ingredients have been mixed into the dough.

Once mixing is complete, the dough can be pumped into a filler, and the dough can be placed in suitable containers, such as by extrusion. The containers can be of any desired shape, such as a tub with snap on lid made of a material such as polypropylene, linear low density polypropylene, or other suitable material. The containers need not be hermetically sealed or pressurized to provide the dough with good microbial stability under refrigeration temperatures. A shrink band may be included to provide evidence of tampering.

Alternatively, the dough may be extruded into a proportioned cookie intermediate. For example, the dough may be extruded to form precisely portioned dough pucks having any suitable shape, such as a round or non-round shape. The dough pucks may then be positioned either manually or automatically on shipping trays. Proportioned cookie intermediates may also be formed by extruding a large sheet of cookie dough, which is then cut or scored to form cookie products. The cookie products may then be positioned either manually or automatically on shipping trays.

The dough described herein and the resulting baked product has a taste, texture and rheology similar to that of typical gluten containing doughs. As describe herein, gluten creates a matrix or structure in a dough through a network of gluten strands. This matrix affects the viscosity and processability of the dough. For example, the gluten matrix is similar to an emulsifying agent which keeps the fats, oils and sugars of the dough together in the dough and prevents separation. The extent of the network of gluten strands impacts whether a mixture is thin and runny, like a batter, or is thick, like a dough. The elimination of gluten in gluten-free products removes the gluten matrix. It has been found that the components of the gluten-free cookie dough described herein provide suitable structure in the dough. For example, egg solids, hydrocolloids or gums and potato starch have been found to improve the structure of the present gluten-free cookie dough.

The dough of the current invention has a rheology similar to that of typical gluten containing doughs. That is, the dough described herein has a satisfactory viscosity and is sufficiently moist to enable the dough to be rolled or formed into suitable shapes for baking, such as balls. Further, the dough described herein is acceptable for commercial production, enabling the dough to be formed in large scale batches, and pumped and extruded into containers for commercial sale.

In some embodiments, the hardness or the ease with which the dough spreads can be determined by a spread test using a texture analyzer. Suitable texture analyzers are available from Stable Micro Systems, United Kingdom, and may be equipped with a TTC spreadability rig also available from Stable Micro Systems. In some embodiments, a dough sample is placed into a female cone-bottomed cylinder of the texture analyzer. A precisely-matching male cone can then be lowered into the sample, forcing the sample to flow upwards and outwards. The force required to move the male cone at a constant rate is measured. The measured force is an indication of the ease with which the sample flows, and the spreadability or hardness of the sample. Suitable force measurements for a spread test can be from about 5,000 to about 14,000 grams force, and more particularly from about 5,000 to about 6,500 grams force.

The dough described herein is spoonable under normal refrigeration conditions, generally about 35-55° F. (1-12.8° C.). By “spoonable”, it is meant that the consumer can readily spoon or scoop the dough from the container. The dough of the invention can be removed from the refrigerator and baked into high-quality baked foods such as cookies. The dough is simply spooned from the container onto a baking pan and baked under normal conditions, e.g., in a 350-375° F. (176.7-190.6° C.) oven for a sufficient amount of time to fully cook the product. The spoonability and outstanding stability of the dough gives the consumer portion control because the consumer can simply spooned out as much or as little of the dough as is desired and store the remaining portion in the refrigerator for later use. The dough will retain its leavening properties and microbial stability for at least about 90 days under refrigerated conditions. If desired, the batter may be frozen for even longer term storage stability.

The dough is shelf stable for at least about 90 days under refrigerated conditions, and in some embodiments up to about 120 days. By shelf stable it is meant that the dough maintains a desired texture, appearance and taste and produces a baked product having a desired taste, texture and mouth feel.

The dough bakes into a baked product that has a taste, texture, and mouth feel similar to that of a gluten containing baked product. As described herein, gluten is responsible for the texture and taste of gluten containing (e.g., wheat flour based) baked goods such as cookies, brownies, and breads. Upon hydration, gluten forms a network of fine strands that give the dough the capacity to stretch and/or rise during baking. The elasticity of gluten enables the dough to trap gases, which create open cellular structures upon baking. The gluten-free flour mixture and other ingredients of the dough described herein mimics the functionality of the gluten containing mixture such that the resulting baked product has a color, rise, spread, texture, flavor and/or mouth feel similar and/or comparable to a gluten containing baked product.

The baked properties of a cookie may be determined based on the height and diameter or spread of a cookie. Sufficient dimensions for cookies include a height from 9 cm to 16 cm and/or a diameter (or spread) from 69 cm to 40 cm. In some embodiments, the height and spread of a dough may be determined based on an average value of a given number, such as eight, baked products.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

Betty Croker Chocolate Chip Dough: a refrigerated ready-to-bake chocolate chip cookie dough available from Betty Croker. This dough includes wheat flour (i.e., contains gluten).

Immaculate Baking Chocolate Chip Dough: a refrigerated ready-to-bake gluten-free chocolate chip cookie dough available from Immaculate Baking Company. This dough is gluten-free.

### Formation of Gluten-Free, Ready-to-Bake Cookie Dough

Ready-to-bake cookie dough of the present invention was prepared by creaming the shortening and sugar together in a spiral dough style mixer. Next, the liquid ingredients, such as water and vanilla, were added to the creamed mixture, followed by the remaining dry ingredients such as the gluten-free flour mixture and leavening system. Chocolate chips were added last to the dough. The mixing was carried out under refrigerated conditions, about 65° F. (18.3° C.).

### Texture Analysis (Spread Test)

A dough sample was placed into a texture analyzer having a female cone-bottomed cylinder. Suitable texture analyzers are available from Stable Micro Systems, United Kingdom, and may be equipped with a TTC spreadability rig also available from Stable Micro Systems. A precisely-matching male cone was lowered into the sample, forcing the sample to flow upwards and outwards. The force required to move the male cone at a constant rate was measured. The measured force is an indication of the ease with which the sample flows, and the spreadability or hardness of the sample.

### Control Formulation

The Control Formulation is provided in Table 3.

TABLE 3
Control Formulation

| | Control |
|---|---|
| | (% wt) |
| Shortening Palm High Oleic canola | 14.47 |
| Granulated Sugar | 4.64 |
| Brown Sugar | 22.16 |
| Xanthan Gum | 0.25 |
| Whole Egg Dried | 2.04 |
| Water | 8.92 |
| Vanilla Extract | 0.51 |
| Potato Starch | 2.04 |
| White Rice Flour | 20.38 |
| Corn Starch | 2.75 |
| Tapioca Starch | 1.27 |
| Salt | 0.56 |
| Baking Soda | 0.51 |
| Chocolate Chips | 19.50 |
| Total Dry % | 56.60 |
| Fat % | 14.47 |
| Flour % | 26.44 |
| Liquid (fat & water) % | 23.39 |
| Egg % | 2.04 |
| Corn starch % | 4.03 |
| Sugar % | 26.80 |

The Control Formulation was subjected to the texture analysis described above, and the results were compared with the Immaculate cookie dough and Betty Crocker cookie dough. The results are presented in Table 4.

TABLE 4
Texture Analysis Results

| | Average force (grams force) |
|---|---|
| Betty Croker Dough | 2,368 |
| Immaculate Baking Dough | 2,296 |
| Control Formulation | 2,192 |

As shown in Table 4, the dough of the present invention (Control Formulation) had an average force comparable to both the Immaculate Baking dough, which is gluten-free, and the Betty Croker Dough, which contains gluten. That is, it took a similar amount of force to compress each dough.

### Exemplary Compositions 1-4

Compositions 1-4 provided in Table 5 are exemplary compositions of the present invention. Table 5 also provides the total dry ingredients, fat, flour, liquid (fat and water) egg, corn starch and sugar by weight of the dough. The compositions may be prepared as described herein. The

TABLE 5
Exemplary Compositions 1-4

| | Ex. | Ex. | Ex. | Ex. |
|---|---|---|---|---|
| | Form. 1 | Form. 2 | Form. 3 | Form. 4 |
| | (% wt) | (% wt) | (% wt) | (% wt) |
| Shortening Palm High Oleic canola | 12.21 | 16.73 | 14.840 | 14.099 |
| Granulated Sugar | 4.759 | 4.514 | 4.755 | 4.518 |
| Brown Sugar | 22.749 | 21.577 | 20.17 | 24.15 |
| Xanthan Gum | 0.261 | 0.248 | 0.261 | 0.248 |
| Whole Egg Dried | 2.092 | 1.984 | 2.090 | 1.986 |
| Water | 9.152 | 8.680 | 9.144 | 8.688 |
| Vanilla Extract | 0.523 | 0.496 | 0.523 | 0.496 |
| Potato Starch | 2.092 | 1.984 | 2.090 | 1.986 |
| White Rice Flour | 20.919 | 19.841 | 20.901 | 19.858 |
| Corn Starch | 2.824 | 2.678 | 2.822 | 2.681 |
| Tapioca Starch | 1.307 | 1.240 | 1.306 | 1.241 |
| Salt | 0.575 | 0.546 | 0.575 | 0.546 |
| Baking Soda | 0.523 | 0.496 | 0.523 | 0.496 |
| Chocolate Chips | 20.016 | 18.984 | 19.999 | 19.001 |
| Total Dry % | 56.60 | 56.60 | 56.60 | 56.60 |
| Fat % | 12.21 | 16.73 | 14.84 | 14.10 |
| Flour % | 27.14 | 25.74 | 27.12 | 25.77 |
| Liquid (fat & water) % | 21.36 | 25.41 | 23.98 | 22.79 |
| Egg % | 2.09 | 1.98 | 2.09 | 1.99 |
| Corn starch % | 4.13 | 3.92 | 4.13 | 3.92 |
| Sugar % | 27.51 | 26.09 | 24.93 | 28.67 |

### Exemplary Compositions 5-8

Compositions 5-8 provided in Table 6 are exemplary compositions of the present invention. The compositions may be prepared as described herein. The

TABLE 6
Exemplary Compositions 5-8

| | Ex. | Ex. | Ex. | Ex. |
|---|---|---|---|---|
| | Form. 5 | Form. 6 | Form. 7 | Form. 8 |
| | (% wt) | (% wt) | (% wt) | (% wt) |
| Shortening Palm High Oleic canola | 14.881 | 14.058 | 14.549 | 14.391 |
| Granulated Sugar | 4.768 | 4.505 | 4.662 | 4.611 |
| Brown Sugar | 22.792 | 21.533 | 22.284 | 22.042 |
| Xanthan Gum | 0.262 | 0.248 | 0.256 | 0.253 |
| Whole Egg Dried | 2.096 | 1.980 | 2.049 | 2.027 |
| Water | 9.169 | 8.663 | 8.42 | 9.41 |
| Vanilla Extract | 0.524 | 0.495 | 0.512 | 0.507 |
| Potato Starch | 2.096 | 1.980 | 2.049 | 2.027 |
| White Rice Flour | 18.12 | 22.64 | 20.491 | 20.268 |
| Corn Starch | 2.829 | 2.673 | 2.766 | 2.736 |
| Tapioca Starch | 1.310 | 1.238 | 1.281 | 1.267 |
| Salt | 0.576 | 0.545 | 0.564 | 0.557 |
| Baking Soda | 0.524 | 0.495 | 0.512 | 0.507 |
| Chocolate Chips | 20.054 | 18.946 | 19.607 | 19.393 |
| Total Dry % | 56.60 | 56.60 | 56.60 | 56.60 |
| Fat % | 14.88 | 14.06 | 14.55 | 14.39 |
| Flour % | 24.35 | 28.53 | 26.59 | 26.30 |
| Liquid (fat & water) % | 24.05 | 22.72 | 22.97 | 23.80 |
| Egg | 2.10 | 1.98 | 2.05 | 2.03 |
| Corn starch | 4.14 | 3.91 | 4.05 | 4.00 |
| Sugar | 27.56 | 26.04 | 26.95 | 26.65 |

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A composition comprising:
from 25% to 30% of a gluten-free flour mixture including less than 30% rice flour by weight of the composition, less than 2.5% potato starch by weight of the composition and at least one starch selected from the group consisting of tapioca starch, corn starch and combinations thereof;
shortening from 10% to 20% by weight of the composition;
sucrose from 21% to 35% by weight of the composition; and
water in an amount less than 12% by weight of the composition,
wherein the composition has a water activity of less than 0.82.

2. The composition of any of claim 1, further comprising from 0.2% to 0.75% of at least one gum by weight of the composition.

3. The composition of claim 2, wherein the gum includes at least one member selected from the group consisting of xanthan gum.

4. The composition of claim 1, further comprising from 1% to 4% of egg solids by weight of the composition.

5. The composition of claim 1, further comprising from 0.2% to 0.75% of at least one leavener by weight of the composition.

6. The composition of claim 1, further comprising from 0.3% to 0.8% of at least one salt by weight of the composition.

7. The composition of claim 1, wherein the rice flour is present in an amount from 18% to 30% by weight of the composition.

8. The composition of claim 1, wherein the potato starch is present in an amount from 1% to 2.5% by weight of the composition.

9. The composition of claim 1, wherein the composition comprises from 3.5% to 4.5% by weight of at least one of tapioca starch, corn starch and combinations thereof.

10. The composition of claim 9, wherein the tapioca starch is present in an amount from 1.2% to 1.5% by weight of the composition.

11. The composition of claim 9, wherein the corn starch is present in an amount from 2.5% to 3% by weight of the composition.

12. The composition of claim 1, wherein the composition is free of gluten protein.

13. A method of manufacturing a raw dough product, the method comprising:
combining rice flour in an amount less than 30% by weight of the raw dough product, potato starch in an amount less than 2.5% by weight of the raw dough product, from 3.5% to 4.5% by weight of the raw dough product of a starch selected from the group consisting of tapioca starch, corn starch and combinations thereof, shortening in amount from 10% to 20% by weight of the raw dough product, sucrose from 21% to 35% by weight of the raw dough product, and water in an amount less than 12% by weight of the raw dough product;
forming a raw dough product; and
packaging the raw dough product, wherein the raw dough product has a water activity of 0.82 or less.

14. The method of claim 13, wherein packaging comprises extruding the raw dough product into a packaging container.

15. The method of claim 13 wherein the rice flour, potato starch tapioca starch and corn starch are present in a total amount from 25% to 30% by weight of the raw dough product.

16. The method of claim 13, wherein the raw dough product further comprises from 0.2% to 0.75% of at least one gum by weight.

17. The method of claim 13, wherein the raw dough product further comprises from 1% to 4% of egg solids by weight.

18. The method of claim 13, wherein the raw dough product further comprises from 0.2% to 0.75% of at least one leavener by weight.

19. The method of claim 13, wherein the raw dough product is free of gluten protein.
